(19) United States
(12) Patent Application Publication
(10) Pub. No.: US 2008/0092044 A1
(43) Pub. Date: Apr. 17, 2008

(54) Cascading clouds

(75) Inventors: Scott M. Lewis, Toronto (CA); Sharon F. Lymer, Toronto (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/548,894

(22) Filed: Oct. 12, 2006

(51) Int. Cl. G06F 3/00

(52) U.S. Cl. 715/713

(57) ABSTRACT

Disclosed herein is a method comprising presenting to a user a tag cloud at level n; wherein the tag cloud comprises an icon located next to each tag in the tag cloud; selecting an icon from the tag cloud at level n; and presenting to the user a tag cloud at level n+1, wherein the tag cloud comprises an icon located next to each tag in the tag cloud at level n+1; wherein the tag cloud at level n+1 comprises a query that comprises the users tag selection from level n in addition to a set of tags from level n+1 that comprise subject matter related to the tag selected at level n; and wherein n is an integer greater than zero.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This disclosure relates to cascading clouds.

2. Background of the Invention

A tag is a keyword or term used to classify content. Tags can be chosen informally and personally by the author/creator of the item—i.e., it is not usually as part of some formally defined classification scheme. Tags are generally used in dynamic, flexible, automatically generated internet taxonomies and folksonomies for online resources such as computer files, web pages, digital images, and internet bookmarks (both in social bookmarking services, and in the current generation of web browsers—see Flock and Mozilla Firefox 2.0×). For this reason, “tagging” has become associated with the Web 2.0 movement.

In general, an item will have one or more “tags” associated with it, as part of some classification software or system. The software will identify relationships between items by virtue of the tags they share. This allows for multiple “browseable paths” through the items that can quickly and easily be altered by the collection's administrator, with minimal effort and planning.

A tag cloud can be used as a visual depiction of content tags used on a website. Often, more frequently used tags are depicted in a larger font or otherwise emphasized, while the displayed order is generally alphabetical, thus both finding a tag by alphabet and by popularity is possible. Selecting a single tag within a tag cloud will generally lead to the listing of a collection of items that are associated with that tag. With this list of items, some sites also display a new tag cloud representing tags related to the currently selected tag. These related tags are the tags that are shared between the items in the list (in addition to the tag that was originally selected). Selecting a tag from this new tag cloud “builds” on the current tag selection to further narrow the list of displayed items. Each time the user refines the selected tags, items are retrieved and the list of items on the web page is refreshed. One problem with this approach is slow performance caused by having to retrieve the items and refresh the page each time the user selects a tag. It is therefore desirable to have cloud tags where a user can retrieve items rapidly without having to refresh the page every time the user selects a tag.

### SUMMARY

Disclosed herein is a method comprising presenting to a user a tag cloud at level n; wherein the tag cloud comprises an icon located next to each tag in the tag cloud; selecting an icon from the tag cloud at level n; and presenting to the user a tag cloud at level n+1, wherein the tag cloud comprises an icon located next to each tag in the tag cloud at level n+1; wherein the tag cloud at level n+1 comprises a query that comprises the users tag selection from level n in addition to a set of tags from level n+1 that comprise subject matter related to the tag selected at level n; and wherein n is an integer greater than zero.

Disclosed herein too is a method comprising presenting to a user a tag cloud from a representative website at level n; wherein the tag cloud comprises an icon located next to each tag in the tag cloud; selecting an icon from the tag cloud at level n; presenting to the user a tag cloud at level n+1, wherein the tag cloud comprises an icon located next to each tag in the tag cloud at level n+1; wherein the tag cloud at level n+1 comprises a query that comprises the users tag selection from level n in addition to a set of tags from level n+1 that comprise subject matter from the representative website related to the tag selected at level n; selecting an icon from the tag cloud at level n+1; and presenting to the user a tag cloud at level n+2, wherein the tag cloud comprises an icon located next to each tag in the tag cloud at level n+2; and wherein the tag cloud at level n+2 comprises a query that comprises the users tag selection from level n and n+1 in addition to a set of tags from level n+2 that comprises subject matter from the representative website related to the tag selected at level n+1; and wherein n is an integer greater than zero.

### TECHNICAL EFFECTS

The cascading tag clouds permit a user to drill down into tag cloud to browse through related tags without actually retrieving items marked with the tags that were previously selected or viewed by the user. This method also permits one to browse through related tags without having to refresh the web page thus improving performance and searching efficiency. It advantageously permits the user to quickly locate the desired tags and then display one list of resulting items. The design provides the user with a method to expand a tag and thereby to show related tags in addition to providing the user with an easily viewable history of the tags that were already reviewed.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 displays a first level of the tag cloud, which contains the tags fruit, meats, vegetables, beverages and grains. Displayed next to each tag in the tag cloud is a plus (+) icon that permits the user to obtain additional tags on related subject matter from the website without refreshing the web page;

FIG. 2 displays a second level of a tag cloud, based upon the user's selection of the tag “fruit” from the tag cloud at the first level. The tag cloud contains a query that depicts the user's current tag choices and, if clicked, will display items with those tags;

FIG. 3 displays a third level of a tag cloud based upon the user's selection of the tag “citrus” from the tag cloud at the second level. As noted above, the tag cloud contains a query that depicts the user's previous tag choice “fruit” as well as the current tag choice “citrus” and also displays a list of tags shared by items that are tagged with both “fruit and citrus”; and

FIG. 4 displays a fourth level of a tag cloud based upon the user's selection of the tag “oranges” from the tag cloud at the third level. As noted above, the tag cloud contains a query that depicts the user's history of tag choices “fruit+citrus+oranges” and also displays a list of tags shared by items that are tagged with “fruit” and “citrus” and “oranges”. In this case, none of the tags in the tag cloud can be further expanded.

### DETAILED DESCRIPTION

Disclosed herein are “cascading clouds” that allow a user to browse through related tags without actually retrieving items marked with the tags that were previously selected or viewed by the user. This method also permits one to browse through related tags without having to refresh the web page thus improving performance and searching efficiency. It advantageously permits the user to quickly locate the desired tags and then display one list of resulting items. The design provides the user with a method to expand a tag and thereby to show related tags in addition to providing the user with an easily viewable history of the tags that were already reviewed.

The term “tag” as used herein is a link which can be selected by the user to navigate a selected website.

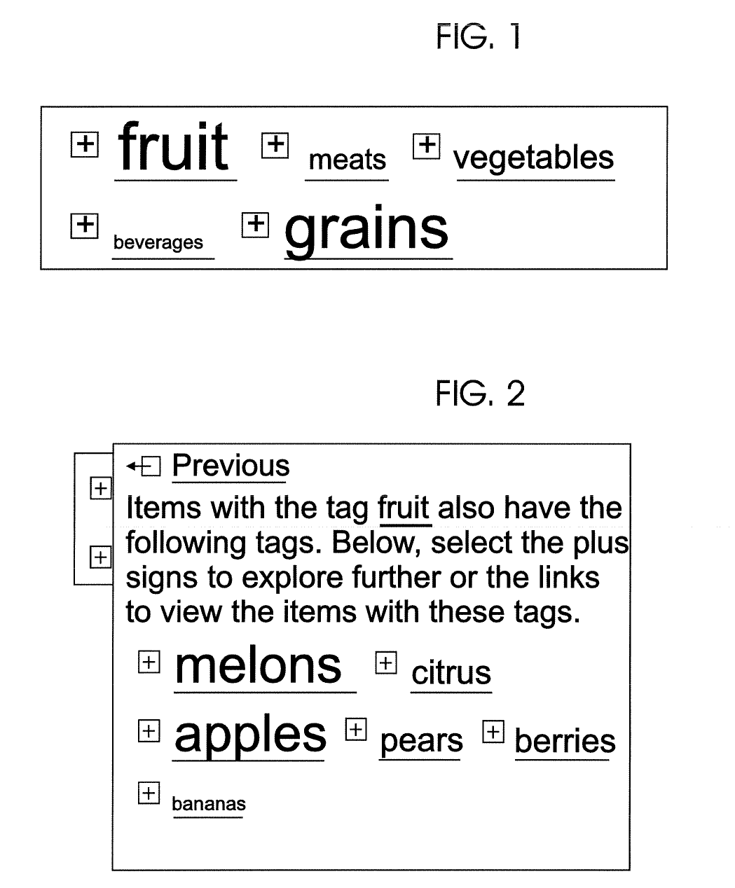

With reference now to the FIG. 1, a first level for a tag cloud depicts a list of tags between which the user desires to make a choice. Each tag has located next to it a plus icon that permits the user to navigate further into the tag space of the website to inquire about a subject of choice. When the user selects the plus icon, the user also activates a new tag cloud that provides the user with a history of tags within the site that have been viewed and shows the tags being used to generate the cloud below which contains tags common to all of the items that are tagged with that tag (“Fruit” in this case).

As depicted in the FIG. 1, the tag cloud offers the user an opportunity to choose between tags on a site that comprise fruit, meats, vegetables, beverages and grains. By selecting the plus sign at this first level, the user can navigate to and interact with another tag cloud located at a second level in the tag space relationship. The tag cloud at the second level comprises tags that are related by subject matter to the tag selected by the user (from the tag cloud) at the first level. By selecting a tag from the tag cloud at the second level, the user can once again navigate to and interact with another tag cloud located at a third level in the tag space relationship, and so on. The tag cloud at the third level is related by subject matter to the tag selected from the tag cloud at the second level.

In addition to tags at the next level that are related by subject matter to the tag selected from the tag cloud at the previous level, the tag cloud displays a query that contains the tags clicked previously which are the tags being used to generate the cloud within.

For example, if in the FIG. 1, the user selects the plus icon located next to the tag “fruit”, the next tag cloud will display a list of those tags related to fruit contained on the site in addition to a query that displays the tag fruit. Thus, as seen in the FIG. 2, the tag cloud contains a query that shows that the user had previously expanded on the tag “fruit”. The tag cloud also contains a new list of tags from the site pertaining to fruit. Thus, since the website, contains tags or a plurality of tags related to melons, citrus, apples, pears, berries, and bananas, the new tag cloud contains a list that contains tags describing these individual fruit. The size of a tag in the new tag cloud can be indicative of the extent of the population of the particular tag in the website.

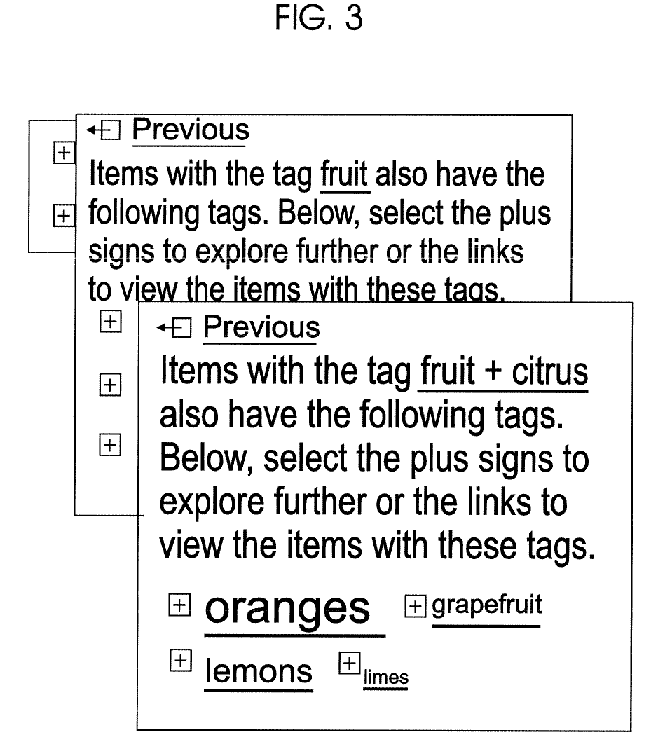

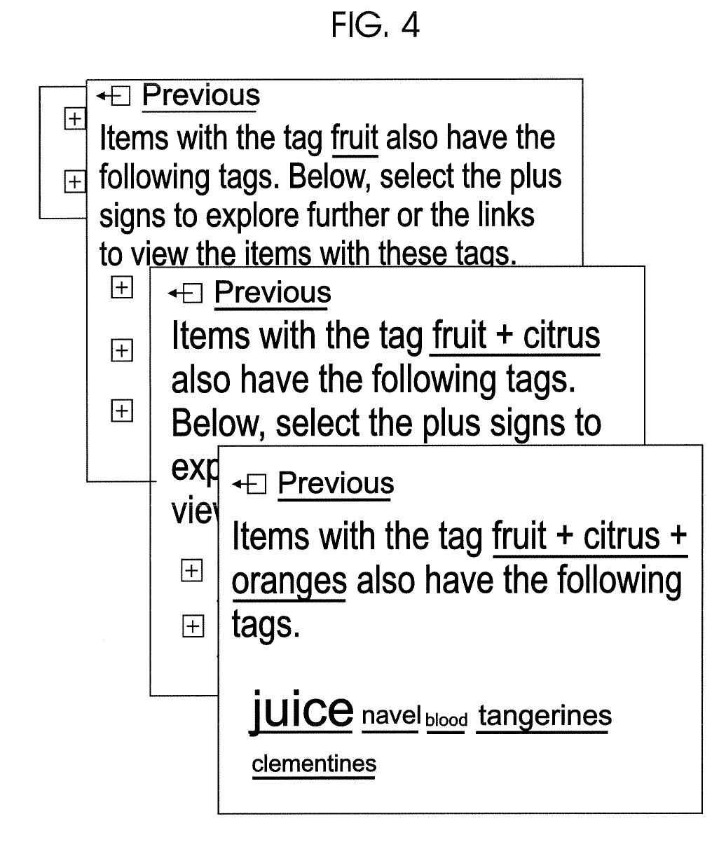

For example, if the user selects the plus icon associated with the tag “citrus” from the tag cloud at this level, the tag “fruit+citrus” appears as the history of the next tag cloud, as seen in the FIG. 3. The tag cloud shown in the FIG. 3, also queries the website and creates a new tag cloud that contains the tags oranges, grapefuit, lemons or limes. If the user should decide to explore the site for additional subject matter related to the tag oranges, then the next tag cloud will display a query that contains tags of the previous sites, namely fruit+citrus+oranges, while at the same time querying the site for subject matter related to oranges. Thus the new tag cloud at this level will display tags that are related by subject matter to oranges such as those exemplary tags shown in the FIG. 4, such as juice, navel, blood, tangerines, clementines, or the like. At this point, no more drilling own trough the tag space is possible so there are no further plus signs within the cloud.

In summary, in one method of proceeding, a system or a website presents to the user a tag cloud at level n, where n is an integer that can occupy any value greater than 0. Thus n can be 1, 2, 3, . . . 100, and so on. The tag cloud comprises plus icons located next to each tag in the tag cloud. The user selects one icon from the tag cloud. In response, the system queries the website and presents to the user a tag cloud that comprises a query that has the users tag selection from level n, while at the same time offering the user a set of tags (with associated icons) from level n+1. The set of tags at level n+1 are related in subject matter to the tag chosen at level n. The user selects one icon from the tag cloud at level n+1. In response, the system queries the website and presents to the user a tag cloud that comprises a query that contains the users tag selection from levels n and n+1, while at the same time offering the user a set of tags (with associated icons) from level n+2. In one embodiment, the aforementioned method is executed by a system that comprises a computer.

While the invention has been described with reference to exemplary embodiments it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method comprising:
presenting to a user a tag cloud at level n; wherein the tag cloud comprises an icon located next to each tag in the tag cloud;
selecting an icon from the tag cloud at level n; and
presenting to the user a tag cloud at level n+1, wherein the tag cloud comprises an icon located next to each tag in the tag cloud at level n+1; wherein the tag cloud at level n+1 comprises a set of tags from level n+1 that comprise subject matter related to the tag selected at level n in addition to a query that comprises the users tag selection from level n; and wherein n is an integer greater than zero.

2. The method of claim 1, further comprising
selecting an icon from the tag cloud at level n+1; and
presenting to the user a tag cloud at level n+2, wherein the tag cloud comprises an icon located next to each tag in the tag cloud at level n+2; and wherein the tag cloud at level n+2 comprises a set of tags from level n+2 that comprises subject matter related to the tag selected at level n+1 in addition to a query that comprises the users tag selection from level n and n+1; and wherein n is an integer greater than zero.

3. The method of claim 1, executed by a computer.

4. The method of claim 1, wherein the icon is a plus sign.

5. The method of claim 1, wherein the tag cloud from level n and the tag cloud from level n+1 are from one website.

6. A system that executes the method of claim 1.

7. A method comprising:
presenting to a user a tag cloud from a representative website at level n; wherein the tag cloud comprises an icon located next to each tag in the tag cloud;
selecting an icon from the tag cloud at level n; and
presenting to the user a tag cloud at level n+1, wherein the tag cloud comprises an icon located next to each tag in the tag cloud at level n+1; wherein the tag cloud at level n+1 comprises a set of tags from level n+1 that comprise subject matter from the representative website related to the tag selected at level n in addition to a query that comprises the users tag selection from level n;
selecting an icon from the tag cloud at level n+1; and
presenting to the user a tag cloud at level n+2, wherein the tag cloud comprises an icon located next to each tag in the tag cloud at level n+2; and wherein the tag cloud at level n+2 comprises a query that comprises a set of tags from level n+2 that comprises subject matter from the representative website related to the tag selected at level n+1 in addition to the users tag selection from level n and n+1; and wherein n is an integer greater than zero.
